(19) United States
(12) Patent Application Publication
(10) Pub. No.: US 2023/0376501 A1
(43) Pub. Date: Nov. 23, 2023

(54) ASIK: MODULAR INTERFACE TO BLOCKCHAIN

(71) Applicant: DLT Global, Inc., Toronto (CA)

(72) Inventor: Neeraj Srivastava, Toronto (CA)

(21) Appl. No.: 17/664,545

(22) Filed: May 23, 2022

(51) Int. Cl. G06F 16/27; G06F 16/23

(52) U.S. Cl. CPC G06F 16/27; G06F 16/2365

(57) ABSTRACT

An Application Specific Integrated Kernel (ASIK) is a modular interface that provides generic solutions to major business needs without the developer having to understand the Blockchain. The ASIK is a collection of APIs for essential use cases that are frequently performed on the Blockchain. The APIs are synchronized with business logic on a Chaincode. A web service layer of the ASIK identifies the business requirements and exposes representational state transfer (REST) APIs from a bundle that may be needed to fulfill a task or operation. A certain transaction request made by the end user is carried out by a generic collection of preconceived scenarios that is configured by the input data collected from the request and converted to Blockchain transactions by the Chaincode. Once the transaction is successfully performed on the Blockchain, the response travels back to the user in the form of a viable output.

### TECHNICAL FIELD

This application is directed to a modular interface to a blockchain and, in particular, to an Application Specific Integrated Kernel (ASIK) that provides generic solutions to business needs by providing a collection of Application Programming Interfaces (APIs) synchronized with business logic on a chaincode.

### BACKGROUND

A blockchain is closely associated in the public's mind with cryptocurrency, the use for which it was invented in 2009. However, the creation of peer-to-peer money was also the invention of an entirely novel approach to distributed computation for other purposes. A wide variety of uses are being explored to take advantage of features like guaranteed data availability, freedom from centralized control, or cryptographic tamper-proofing.

The current energy around blockchain adoption is reminiscent of early adoption of the Internet. The potential exists to either re-live or avoid the same missteps with respect to logic management that weighed down applications and systems as they matured. Analogous to early websites and applications, cryptocurrency uses of blockchain featured relatively simple data structures and hard-coded business logic to govern them. However, the subsequent invention of “smart contracts” opened the door for rules and data of arbitrary complexity.

Enterprise use cases like supply chain logistics are putting information and logic on a blockchain in volumes that rival traditional solutions, but with none of the standardized data management tools. With every programmer designing his/her own logic set within the application code base, the result once again is logic coupled tightly to the programs (smart contracts) that write it.

It is noted that not every feature of blockchain needs to be used in an enterprise application. Common situations include the use of blockchain platforms as a convenient way to achieve features like cryptographic tamper proofing and data replication. Enterprises also may implement a blockchain network under their full control, with relaxed consensus rules or a centralized front end, perhaps as a first step toward a more distributed application in the future. In addition, consortia with high levels of trust setting up blockchain networks together with strict smart contract enforcement for support staff may allow administrators and internal auditors to update blockchain data directly on their own authority.

Transaction data and decisions stored in a smart contract has greater value in applications. Transaction data and node functions stored in the blockchain can be used subsequently in other functions or logic without being governed by consensus, thereby making the operations quick, efficient, and reliable. The only required feature is the access to use the data stored on the blockchain. The data stored on blockchain can be efficiently read and processed by an application, or node functions, or system either inside or outside of the blockchain, for purposes that go beyond what was envisioned by the original smart contract programmers.

Considering the dynamic nature of product development, applications focused on unilateral solutions are becoming obsolete. The costs to pause and upgrade these applications may be too great for many businesses. Frequent maintenance sessions not only point towards poor performance but also adds to expenses. Change in logic and product blueprints often alter the look and feel of the product that ultimately affects the user experience. Developing products from emerging technologies such as Blockchain is particularly tedious and may require lots of resources. Distributed ledger technology platforms offer rigorous data replication, rule enforcement, and immutability and auditability, but often require specialized skills to program and operate.

### SUMMARY

The systems and methods described herein address the needs in the art by providing an application specific integrated kernel (ASIK) that interfaces a client application to a blockchain platform that manages a blockchain. The ASIK includes an application programming interface (API) layer that receives a request from the client application to perform a transaction on the blockchain. The API layer formats data associated with the request. The ASIK further includes a service layer that receives at least one command and formatted data associated with the request, identifies a type of the request, and based on the type of the request, forwards the at least one command and formatted data for execution on the blockchain and returns a result of the processing of the at least one command and formatted data on the blockchain to the client application. The service layer further describes preconfigured features and functionalities that are to interact with the blockchain platform in accordance with a predetermined use case (e.g., a business service) of the application specific integrated kernel. The ASIK also includes a chaincode that manages data operations for the preconfigured features and functionalities that are to interact with the blockchain platform for the predetermined use case by translating the at least one command into at least one transaction that can be executed on the blockchain platform in accordance with the preconfigured features and functionalities for the predetermined use case and by returning results of execution of the at least one transaction and formatted data on the blockchain platform to the service layer.

In sample configurations, the API layer exposes APIs that the client application uses to access the preconfigured features and functionalities that are to interact with the blockchain platform in accordance with the predetermined use case of the application specific integrated kernel. The API layer also may provide load balanced representational state transfer (REST) APIs to the client application, where the REST APIs are adapted to interact with the blockchain platform. The API layer may further validate the request from the client application, validate user details received in the request from the client application, check permission for the user to perform the request from the client application, prepare the request for submission to the blockchain platform, and return a response from the blockchain platform to the client application.

In other sample configurations, the API layer, service layer, and chaincode may be adapted to support a multi-tenant framework whereby multiple client applications may create and manage data on the blockchain platform. The API layer, service layer, and chaincode also may be adapted to support three roles comprising a Platform Admin, a Tenant, and Core ASIK Participants. The Platform Admin may be responsible for enrolling client applications. The Tenant may have an ID and resources allocated to it that can be used to perform create, read, update, and delete operations on the formatted data. The Core ASIK Participants may have their own ID which is used to initiate requests with the API layer. A database also may be provided for each Tenant whereby each Tenant performs operations in its own database.

In further sample configurations, the service layer may describe the preconfigured features and functionalities by outlining a semantics and syntax and at least one interface through which the at least one command and formatted data interact with the blockchain platform for the predetermined use case of the application specific integrated kernel. The service layer may further accept inputs from the API layer and translate the inputs to action by invoking the chaincode and a state database.

In still further sample configurations, the chaincode may access a blockchain ledger and smart contracts of the blockchain platform to query or update the blockchain ledger. All operations of the client applications may be logged securely to the blockchain ledger.

The description herein further relates to a method for interfacing a client application to a blockchain platform that manages a blockchain by performing operations comprising receiving, by an application programming interface (API) layer, a request from the client application to perform a transaction on the blockchain; formatting, by the API layer, data associated with the request; receiving, by a service layer, at least one command and formatted data associated with the request; identifying, by the service layer, a type of the request; based on the type of the request, forwarding, by the service layer, the at least one command and formatted data for execution on the blockchain; managing, by a chaincode, data operations by translating the at least one command into at least one transaction that can be executed on the blockchain platform in accordance with preconfigured features and functionalities that are to interact with the blockchain platform in accordance with a predetermined use case (e.g., business service); and returning results of execution of the at least one transaction and formatted data on the blockchain platform to the client application.

In sample configurations, the method may further include exposing APIs to the client application that the client application may use to access the preconfigured features and functionalities that are to interact with the blockchain platform in accordance with the predetermined use case. The method may further include providing load balanced representational state transfer (REST) APIs to the client application, where the REST APIs are adapted to interact with the blockchain platform. The formatting of data associated with the request may include the API layer validating the request from the client application, validating user details received in the request from the client application, checking permission for the user to perform the request from the client application, and preparing the request for submission to the blockchain platform.

In other sample configurations, the method may further include enabling multiple client applications to create and manage data on the blockchain platform using the API layer, service layer, and chaincode. The API layer, service layer, and chaincode also may be adapted to support three roles comprising a Platform Admin, a Tenant, and Core ASIK Participants. The Platform Admin enrolls client applications. The Tenant performs create, read, update, and delete operations on the formatted data using an ID and resources allocated to the Tenant, and the Core ASIK Participants initiates requests with the API layer using their own IDs. Each Tenant also may perform operations in its own database.

In further sample configurations, the method may further include the service layer describing the preconfigured features and functionalities by outlining a semantics and syntax and at least one interface through which the at least one command and formatted data interact with the blockchain platform for the predetermined use case. The method may also include the service layer accepting inputs from the API layer and translating the inputs to action by invoking the chaincode and a state database.

In still further sample configurations, the method may include the chaincode accessing a blockchain ledger and smart contracts of the blockchain platform to query or update the blockchain ledger and securely logging all operations of the client applications to the blockchain ledger.

The description herein also includes a non-transitory computer-readable medium having instructions stored thereon that when executed by one or more processors cause the one or more processors to implement the method for interfacing a client application to a blockchain platform that manages a blockchain. In sample configurations, the instructions implement an application programming interface (API) layer that receives a request from the client application to perform a transaction on the blockchain and formats data associated with the request; a service layer that receives at least one command and formatted data associated with the request, identifies a type of the request, and based on the type of the request, forwards the at least one command and formatted data for execution on the blockchain, and returns results of execution of the at least one command and formatted data on the blockchain platform to the client application; and a chaincode that manages data operations by translating the at least one command into at least one transaction that can be executed on the blockchain platform in accordance with preconfigured features and functionalities that are to interact with the blockchain platform in accordance with a predetermined use case.

The embodiments described herein also encompass computer systems for implementing the methods described throughout this disclosure. For example, the systems and methods described herein may be implemented on a computing platform in the cloud to provide functionality for accessing and storing data to a blockchain platform as described herein.

### BRIEF DESCRIPTION OF THE DRAWINGS

The present disclosure is illustrated by way of example and not limitation in the figures of the accompanying drawings, in which like references indicate similar elements and in which:

FIG. 1 is a general block diagram providing an overview of the specifications and core components of an Application Specific Integrated Kernel (ASIK) in an illustrative example.

FIG. 2 is a detailed component diagram of a Fabric/Node.js® implementation of an ASIK in a sample configuration.

FIG. 3 is a diagrammatical view of ASIK Track system objects for an implementation of an ASIK Track application in a sample configuration.

FIG. 4 is a flow diagram illustrating the control flow of a sample configuration of an ASIK Track application.

FIG. 5 is a flow diagram illustrating the operation of an ASIK in a general configuration.

FIG. 6 is a block diagram of a typical, general-purpose computer that may be programmed into a special purpose computer suitable for implementing one or more configurations of the ASIK disclosed herein.

### DETAILED DESCRIPTION

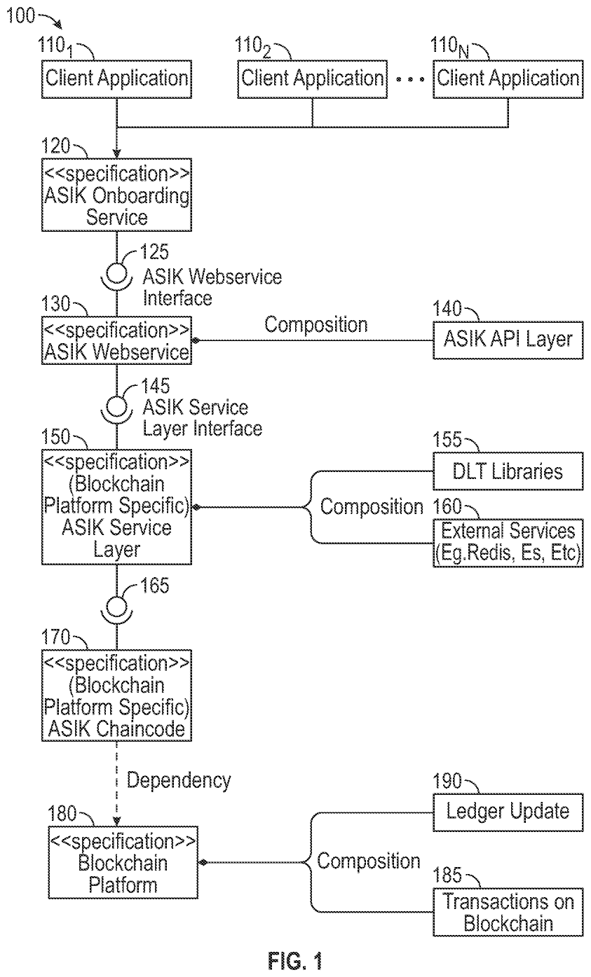

The following description with respect to FIGS. 1-6 sufficiently illustrates specific embodiments to enable those skilled in the art to practice them. Other embodiments may incorporate structural, logical, process, and other changes. Portions and features of some embodiments may be included in, or substituted for, those of other embodiments. Embodiments set forth in the claims encompass all available equivalents of those claims.

### Terminology

Blockchain: A continuously growing list of records, called blocks, are linked and secured using cryptography. Each block typically contains a cryptographic hash of the previous block, a timestamp, and transaction data. The Blockchain is designed to be inherently resistant to modification of the transaction data. For use as a distributed ledger, a Blockchain is typically managed by a peer-to-peer network that collectively adheres to a protocol for validating new blocks. Once recorded, the data in any given block cannot be altered retroactively without the alteration of all subsequent blocks, which requires collusion of the network majority.

BNO: A Blockchain Network Orchestrator (BNO) is a service that an ASIK Track Application uses to configure and manage the Blockchain network. BNO helps users to create Ethereum, Fabric network, and Element DB instances (Element DB is a product of the assignee that provides the ability for organizations and users to manage relational data on the Blockchain).

Chaincode: A Chaincode is a smart contract or software that represents business logic for every client (organization) to read and update data on a Blockchain ledger in a sample configuration. In the ASIK Track Application, the Chaincode is upgraded by the Platform Admin.

Core ASIK Participants: Anyone who tries to access the ASIK application via a client application can be called a Participant. Core ASIK Participants have their own ID, which is used by the ASIK to initiate requests with the ASIK's API layer. For example, the following are different participants in the ASIK Track example described herein:

Supply Chain Admin: The Supply Chain Admin is the admin of the application. It can create different users/user groups, workflows, etc. The Supply Chain Admin can view all entities like Workflows or Movable Products, but it cannot perform operations on those entities.

Auditor: Auditor is an external participant who can see all the data of a Movable Product and can resolve disputes.

Internal Auditor: Internal auditor can view all the data of a Movable Product, can resolve disputes, and is an internal participant.

User/Participant: Users have the authority to create/transfer/receive Movable Products. Each user can belong to multiple user groups as well as each user group having multiple users who can transfer, receive, or reject the child product which is associated with an existing base product and a Workflow.

CouchDB® is incorporated in Hyperledger® Fabric as an option for the world state database, a database that holds current values of a set of ledger states. CouchDB® supports rich queries when Chaincode data values are modeled in JSON as the transaction data for the ASIK.

Dispute: Any discrepancy in the attributes of a product is termed a Dispute. A Dispute could be anything deviating from something that all the participants have agreed upon. A Dispute can be created by a User at any point in time for a Movable Product. The Dispute can be resolved either by an Auditor or by a User.

Hyperledger® Fabric: An enterprise grade permissioned distributed ledger platform that offers modularity and versatility for a broad set of industry use cases.

Hyperledger® Fabric Certificate Authority: The certificate authority (CA) provides certificate services to users of a blockchain. More specifically, these services relate to user enrollment, transactions invoked on the Blockchain, and transport layer security (TLS)-secured connections between users or components of the Blockchain. The enrollment certificate authority (ECA) allows new users to register with the Blockchain network and enables registered users to request an enrollment certificate pair. One certificate is for data signing, and one is for data encryption. These certificates are to be used for invoking Chaincode transactions on the Blockchain.

JSON: JavaScript Object Notation, a lightweight, text-based, human-readable data-interchange format.

Movable Product: The Movable Product is the actual product that gets transferred from one node to another. A User can create, transfer, receive, update, and reject a Movable Product.

Nest (NestJS): A framework for building efficient, scalable Node.js® server-side applications. NestJS uses progressive JavaScript, is built with and fully supports TypeScript (yet still enables developers to code in pure JavaScript), and combines elements of OOP (Object Oriented Programming), FP (Functional Programming), and FRP (Functional Reactive Programming). More information about NestJS may be found at “About NestJS, documentation and foundation, https://nestjs.com/.

Node.js®: A free open-source server environment that executes JavaScript code outside of a browser. Node.js® is an asynchronous programming platform built on the Chrome browser's JavaScript runtime. More information about Node.js® may be found at “About Node.js®.” Node.js, Node.js Foundation.

Platform Admin: Platform Admin is enrolled at the time of product deployment. A role of Platform Admin, specially designed for this, only has the privilege to create and manage Tenants in the ASIK.

Product: Product is metadata for all the Movable Products. Multiple Movable Products may be created for a single product.

Smart Contract: A computer protocol that provides the general-purpose computation that takes place on the Blockchain or distributed ledger. The smart contract Transactions may be simple or may implement sophisticated logic. The resulting transactions are typically transparent to ledger participants, trackable and irreversible.

Tenant: A Tenant is registered by the Platform Admin of the ASIK. A Tenant represents any client (organization) using the ASIK. The ASIK provides the feature to let multiple clients use a single application, which is called multi-tenancy. Tenants have an ID and the resources allocated to it, which they can use to perform required CRUD (create, read, update, and delete) operations on any asset in the ASIK.

Tracker: For every Movable Product, one Tracker document will be created. It contains all the historical information for a Movable Product, including the attribute updates and movement of the Movable Product.

Workflow: A workflow determines the sequence of the user groups in which the product will be transferred, and the attributes associated with the base product.

### Overview

Computer application designers, especially in large-scale enterprise settings, are increasingly incorporating existing distributed ledger technology (DLT) platforms into their solutions. As noted above, these platforms offer rigorous data replication, rule enforcement, and immutability and auditability, but often require specialized skills to program and to operate. As will be described herein, subsystems may be used that enable the creation and operation of client applications by developers without specialized skills in the selected platform by combining an abstraction of communication of a proximate DLT node (including the writing of both data and rules for that data) with a set of data and rule primitives that will support a broad range of potential DLT applications within a category (e.g., for a particular use case). The primitives are typically constructed such that application developers may adapt them to specific use cases, extending them with attributes and additional data rules without requiring DLT platform skills, and without losing the rigorous rule enforcement that the DLT platform provides. Also, the interface(s) by which client application developers design and act on these primitives fully abstracts away any need for a technical understanding of the DLT platform.

Specific implementations may be dedicated subsystems of a single client application, reusable components for use with many client applications, or services that provide application enablement to many client applications. Other implementations may mediate the communication with one or many proximate DLT nodes, and those nodes may be drawn from a single or multiple DLT networks.

The description herein is provided with respect to Hyperledger® Fabric, but it will be appreciated by those skilled in the art that the techniques described herein also may be used with other Blockchain networks such as AION, ArcBlock, EOS, NEO, Hyperledger® Sawtooth, NxT, QTUM, Quorum, Smilo, Tezos, TRON, Wanchain, or Zilliqa. The terminology used herein is with respect to the Hyperledger® Fabric blockchain network. Corresponding terms would be used in the context of the other Blockchain networks, such as those mentioned.

A sample subsystem may enable the indirect use of a Hyperledger® Fabric DLT platform for a broad category or hypothetical workflow and information sharing applications, as well as several operational real-world realizations of such client applications. To implement such a subsystem, there are three key requirements:
1. A set of extensible generic data and action primitives that will be represented on the distributed ledger;
2. A set of rules operating on those primitives, embedded in the distributed ledger, that enforce both the endemic data rules of the subsystem plus permissible extensions of those rules as may be provided by the client application; and
3. A programming interface that requires no knowledge of the Blockchain platform to operate.

The resulting subsystem provides a suite of tools and a library that enables an ordinary user with knowledge of some application category and/or skills in some Blockchain platform to construct their own subsystem to support the creation of client applications in that category. The resulting code is implemented as middleware between an API network and a Blockchain protocol whereby the user may interface to the Blockchain consistently without extensive knowledge of the operation of the Blockchain. In such applications, use case specific business rules from an upper layer are written and enforceable on the Blockchain. New business rules may be added from time to time to update the Workflow without disrupting the Blockchain capabilities and controls.

An Application Specific Integrated Kernel (ASIK) as described herein is a modular interface that provides generic solutions to major business needs. As described herein, an ASIK is a collection of APIs synchronized with business logic on a Chaincode that gives it a ‘Plug and Play’ nature, keeping things very simple. The web service layer of the ASIK identifies the business requirements and exposes representational state transfer (REST) APIs from a bundle that may be needed to fulfill a task or operation. This functionality makes the ASIK a generic solution that may be implemented in almost any vertical. As will be apparent from the following description, an ASIK is a multi-utility application that may be implemented in asset tracking, supply chain management, consent management, financial solutions, access control, product inventory, and many more applications.

Generally, the ASIK is a collection of APIs for essential use cases that are frequently performed on the Blockchain. A certain transaction request made by the end user is carried out by a generic collection of preconceived scenarios that is configured by the input data collected from the request. Once the transaction is successfully performed on the Blockchain, the response travels back to the user in the form of a viable output.

The ASIK's value comes from the fact that it is ready to use without having to understand the Blockchain. In addition, the ASIK provides a generic solution that can be shaped to meet all major business requirements. The ASIK is highly ‘pluggable and reusable’ in that users have minimal factors to configure to use the ASIK for their requirements. As the ASIK provides a generic solution, it evolves with the growth of market or rapidly changing requirements. The ASIK can be integrated to be used with several external application types, thus making it a multi-utility application. The ASIK also is continuously ‘evolving’ that always has room for new features and upgrades making it a fast ultra-modern solution. The ASIK is also a ‘black box to the blockchain’ in that an ASIK is a reliable interface between users and the Blockchain. Users do not have to understand the concepts of a Blockchain to reap the benefits that the ASIK provides. The ASIK's ease of access enables it to be integrated with external systems without any difficulty. The ASIK is functions in almost every recognizable Blockchain network that supports development. The ASIK is also compatible with cloud-based platforms making it versatile and easy to deploy/integrate.

An ASIK may be implemented in a number of different applications including:

ASIK Track—A platform that empowers organizations to configure and deploy a sophisticated, autonomous fintech enabled information supply chain with a built-in marketplace for all participating organizations. An embodiment of ASIK Track will be described below as an example implementation.

ASIK Ecosystem—A platform that enables peer to peer banking. Because it is built using distributed ledger technology, every transaction is 100% auditable, immutable, and visible only to permissioned users, thus helping to create a genuine layer of trust between the parties that transact on the platform.

ASIK Consent—A fully executable data consent management platform that defines an entirely new way of data collection and notifies the user each time their data is used, thereby allowing the user to give and revoke consent in real-time.

ASIK Certify—A verification platform that uses a combination of blockchain and distributed technologies to ensure 100% verification for digital assets.

### Sample Embodiment of ASIK

As noted above, applications just focused on unilateral solutions are becoming obsolete and the process of pausing and upgrading them will simply lead to poor performance and added expenses. A business solution is needed that roots from emerging technologies like blockchain, while being universal and extremely easy to use. However, developing such products using influential technology is tedious and requires a lot of resources. Migrating to a different technology stack is a considerable challenge, which is not the most viable option for many businesses.

The ASIK described herein addresses these needs in the art by providing a reusable and pluggable service that can be leveraged by Blockchain as well as non-blockchain applications. The ASIK described herein has been designed for implementation across a variety of Blockchain platforms and user programming languages. Parts of the system may be customized but follow a set of common specifications. This description provides a description of one such implementation based on the Hyperledger® Fabric platform and Node.js® programming language. However, it will be appreciated that the description provided herein may be readily extended by those skilled in the art to other platforms and languages.

A description of a set of specifications, interfaces and core components for all implementations of an ASIK now will be provided with respect to FIG. 1.

FIG. 1 is a general block diagram providing an overview of the specifications and core components of an Application Specific Integrated Kernel (ASIK) 100 in an illustrative example. FIG. 1 is an adapted component diagram demonstrating the components and specifications of an ASIK in a sample configuration. The common specifications are represented as components with the «specification» stereotype to indicate abstract requirements. Specifications are aspects that are expected to be implemented in a common way among all ASIK implementations. The interfaces shown are also specifications in common for all implementations.

In FIG. 1, the client application 110₁-110_{N} is the application that intends to utilize the ASIK 100. The client application 110₁-110_{N} may be any third-party application, service, or tool. There could be multiple client applications 110₁-110_{N} or Tenants accessing the ASIK 100. The client applications 110₁-110_{N} access the ASIK 100 via the ASIK Tenant Onboarding Service 120, which handles multiple clients or Tenants and lets them all use the ASIK 100 efficiently. The ASIK Tenant Onboarding Service 120 interacts with the ASIK Webservice 130 via an ASIK Webservice Interface 125. ASIK Webservice 130 is the component that receives the commands from the HTTP requests and communicates with inner components of the ASIK 100 to produce the desired result. The ASIK Webservice 130 provides a service that connects directly with the client application 110₁-110_{N} and, based on the requirements, may forward the request to the other services in the service layer. Thus, the ASIK Webservice 130 may be considered to be a master service that does the initial processing of the data, identifies the type of the request, and based on the type, forwards the request further to complete the processing and then returns the result (intermediate or final) back to the client application 110₁-110_{N}. The ASIK API Layer 140 handles the REST calls and is also implemented in the ASIK Webservice 130 to manipulate/format the data and send the data to various other components.

The ASIK Webservice 130 interacts with the Blockchain platform specific ASIK Service Layer 150 via the ASIK Service Layer Interface 145. The Blockchain Platform ASIK Service Layer 150 is designed to work with Blockchain systems (Hyperledger Fabric in this example) and accepts input from the ASIK API layer 140 via ASIK Webservice Layer 130 to execute the business logic. The ASIK Service Layer 150 may contain one or more interconnected services such as those available via DLT Libraries 155 or External Services 160. The DLT Libraries 155 and External Services 160 communicate with each other by, for example, using Apache Kafka queues. The Blockchain Platform ASIK Service Layer 150 describes an interface, plus the functionalities that are to be supported in every realization (use case) of the ASIK 100. Apart from covering the entire interface, the specification of the Blockchain Platform ASIK Service Layer 150 also covers the subset of features and functionalities that may be realized in either this Blockchain Platform ASIK Service Layer 150 or on the Blockchain Platform 180 itself.

The Blockchain Platform ASIK Service Layer 150 accepts input from the ASIK Webservice API Layer 140 and performs the following steps:
1. Validate and sanitize the request received.
2. Validate the user and Tenant details received in a request.
3. Check permission for the user to perform the requested operation.
4. Prepare the transaction/request object to submit it on the Blockchain platform 180.
5. Submit the transaction on the Blockchain Platform 180.
6. Prepare the success/error response object based on the response returned from step 5.
7. Return the response to the client.
   The Blockchain Platform ASIK Service Layer 150 is implemented in Node.js® in a sample configuration and is independent of the programming language and thereby could be implemented in any language for any targeted Blockchain Platform 180. Once the data is converted into the desired form, the Blockchain Platform ASIK Service Layer 150 invokes the Blockchain Platform Specific ASIK Chaincode 170 via an interface 165. The Blockchain Platform Specific ASIK Chaincode 170 in turn invokes the Blockchain Platform 180. Additional features may be targeted on Blockchain Platform 180 itself.

In sample configurations, the data operations in the ASIK 100 are managed by the ASIK Chaincode 170 and the Blockchain Platform 180 together. The exact division of work depends on the capabilities of the Blockchain Platform 180. The required functionality is given by two sub-specifications. Transactional Data on Blockchain 185 defines the standardized data representations (JSON Schemas) and data operations that are to be supported. The transactional data contains documents of type workflow, movable product, product, supply chain admin, auditor, internal auditor, tracker, user, user group, dispute, etc. Ledger Update 190 provides, whenever transactions are executed on the Blockchain, a transaction with a unique ID that is updated on the ledger that keeps track of all the transactions made by the enterprise.

During operation, of ASIK 100, The ASIK Tenant Onboarding Service 120 provides a multi-tenant framework that supports multiple instances of software run on a single physical server and supports multiple users to use a single application, e.g., a database or certain microservices. As seen in FIG. 1, several client applications (Tenants) 110₁-110_{N} may try to access the ASIK 100. The ASIK Tenant Onboarding Service 120 handles these multiple Tenants so that they can all use a single ASIK 100. By incorporating the multi-tenant feature, the ASIK 100 is cost effective in that resource sharing reduces the system cost. Also, because all users access their services from the same technology platform, it is much easier to access automatic and frequent updates. The users do not need to pay the charges for separate resource allocations. The hosting is also simplified and is hardware independent. Multi-tenancy provides the ability to reside in the same infrastructure and data center where more server or computing capacity may be readily added. Multi-tenancy also provides reduced exposure to malicious software as well as hassle-free upgrades. Also, because of the multi-tenant feature, virtualization and remote access features can be used completely within an enterprise.

The multi-tenancy creation is dictated by resources allocation of the Blockchain Platform 180 (e.g., Fabric), and this allocation can be dedicated or shared (depends on the client/user request). The multi-tenancy creation also may be dictated by channel creation and Smart Contract deployment, CouchDB® view creation, Kafka topic partition creation, and Elasticsearch Indices creation in sample configurations.

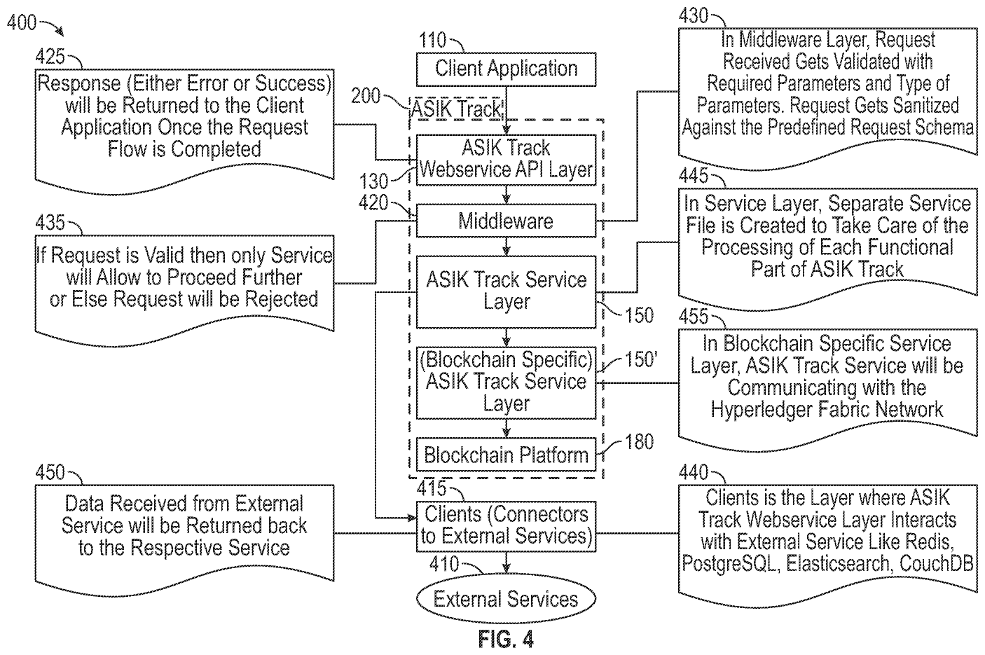

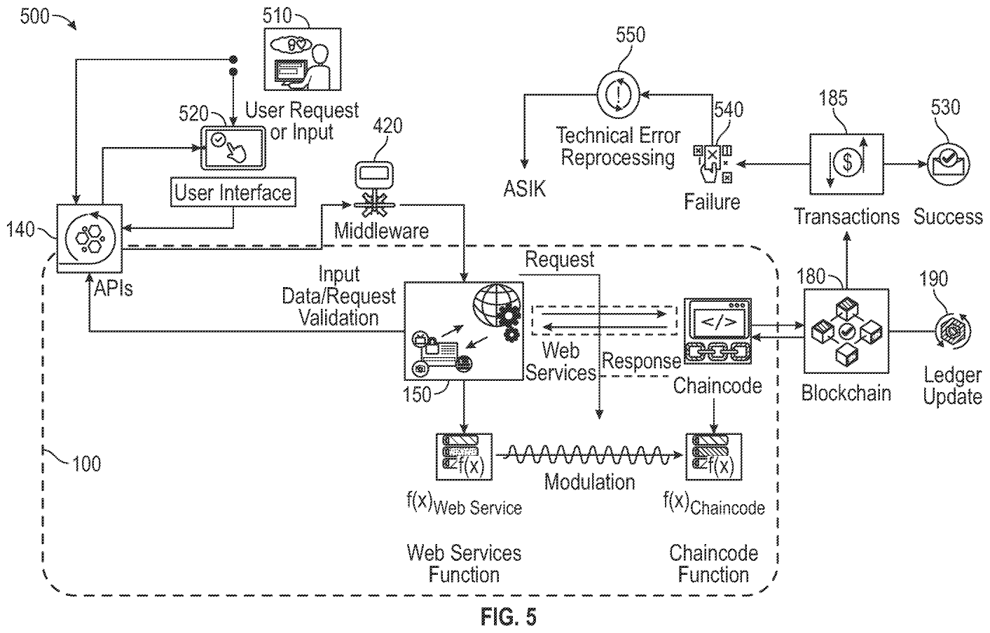

As noted above with respect to FIG. 1, one of the core components of ASIK 100 is the ASIK Webservice 130 that is used in all the realizations of ASIK 100. The ASIK Webservice 130 may act as an interface between the client application 110₁-110_{N} and the ASIK 100. The user can make a request via a Software Development Kit (SDK) or an interface to the application or via HTTPS Requests (or requests made from RESTful APIs). All of these requests may be received, processed, and transferred (to other components) through the sub-components of the ASIK Webservice 130. One of such sub-components is the ASIK API layer 140, which accepts the input in the form of acceptable syntaxes. The middleware (FIGS. 4-5) does the heavy work of parsing, validating, and formatting these syntaxes to make sure that all the parameters are in line with the business requirements and then routes the syntaxes to the ASIK Service Layer 150 and other succeeding components.

Depending upon the business needs, appropriate functions to cater the requirements are selected by the ASIK 100 and the service layers provide those functions. The Blockchain Platform Specific ASIK Service Layer 150 is independent of the programming language and thereby could be implemented in any language. The services are developed using Node.js® and NestJS. The Blockchain Platform Specific ASIK Service Layer 150 can be re-used and is independent of the blockchain framework. The Blockchain Platform Specific ASIK Service Layer 150 specification describes an interface, plus the functionalities that needs to be supported in every realization of ASIK 100. The Blockchain Platform Specific ASIK Service Layer 150 may contain multiple sub-services interconnected through http requests, kafka, or any other protocol. In addition, several DLT libraries 155 (e.g., dlt-kafka) also may be implemented in the Blockchain Platform Specific ASIK Service Layer 150 of the ASIK 100 to attain high reusability of existing functionality. For example, dlt-kafka provides a mechanism to connect to kafka thereby exposing functions like produce/consume that any service can use rather than implementing it. All the connections to the external services 160 like redis, elastic search, CouchDB®, etc., may be established in the Blockchain Platform Specific ASIK Service Layer 150 itself.

The request function in the Blockchain Platform Specific ASIK Service Layer 150 then triggers a similar function on the ASIK Chaincode 170. The function acts as a modulator that translates input requests into transactions that can be executed on the Blockchain platform 180 via the ASIK Chaincode 170. This business problem is solved in the ASIK Chaincode 170 which is responsible for all interactions with the Blockchain platform 180.

Like the platforms themselves, the implementations of the functionality that is to be implemented directly on the Blockchain platform 180 will differ greatly in approach. The corresponding specifications set out what still will be common regardless of the Blockchain Platform 180 being used. Whenever transactions are executed on the Blockchain Platform 180, irrespective of the status of the transaction, i.e., success or failure, a transaction with a unique ID is updated on the ledger 190 that keeps track of all the transactions made by the enterprise. The smart contracts and/or Chaincode 170 can be customized by the ASIK 100 to further enhance the transaction reports. When the business operations are completed (success scenario), the state of the transactions is then updated onto a preconfigured state database that holds the current state of data. The ASIK 100 may us CouchDB® as the state database, which allows storage of data in JSON format, issuance of JSON queries against the data, and use of indexes to support the queries. On the other hand, whenever a transaction fails, an error handling system may assign the transaction to ASIK 100 as appropriate.

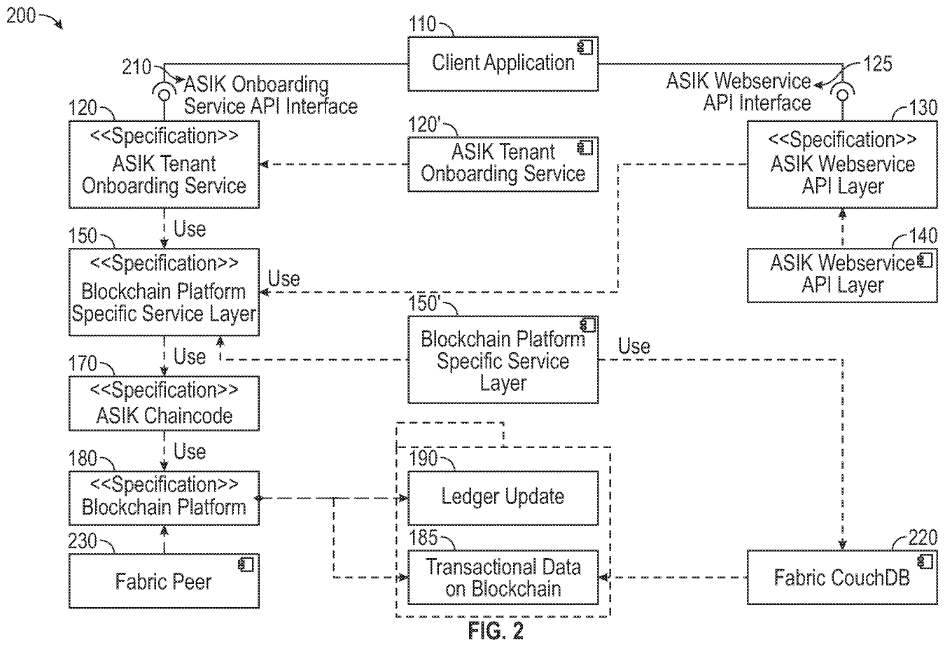

In a sample configuration shown in FIG. 2, a configuration of the ASIK 100 is implemented using Node.js®, the Hyperledger® Fabric blockchain platform based on the Node.js® SDK, and Apache CouchDB®. Node.js® is currently the world's most popular framework for web server-side development, while Hyperledger® Fabric has an architecture that partially satisfies a number of the requirements of ASIK 100. Apache CouchDB® is incorporated in Hyperledger® Fabric as an option for a world state database. CouchDB® supports rich queries when chain code data values are modeled in JSON as ASIK data.

As noted above, the ASIK 100 is a ‘Plug and Play’ solution equipped with preconfigured scenarios. Request are fed to the ASIK Webservices 130 from client applications 110₁-110_{N} using conventional user interface (UI) methods or HTTP requests. In order to make transactional data capabilities available, smart contracts are also implemented on the Blockchain Platform 180. Hyperledger® Fabric is an implementation of blockchain technology and has been collaboratively developed under the Linux Foundation. The Hyperledger® Fabric blockchain platform is suitable as it meets all of the requirements of the specification as noted above, and further provides excellent performance, logical data separation between Tenants and applications, and tight integration with the Blockchain Platform 180.

FIG. 2 is a detailed component diagram of a Fabric/Node JS implementation 200 of an ASIK 100 in a sample configuration. FIG. 2 describes the implementation of an ASIK Track configuration 200 where Node.js® is the programming language and Hyperledger® Fabric is the Blockchain platform used. FIG. 2 illustrates how the Fabric/Node.js® implementation realizes the specifications outlined in FIG. 1 along with some additional functionalities. From FIG. 2, it will be appreciated that the ASIK data realization on Fabric involves providing the ASIK implementation 200 with three roles in total: Platform Admin, Tenant, and Core ASIK Participants. Platform Admin is enrolled at the time of product deployment. This role is responsible for enrolling Tenants into the system. Tenants have an ID and the resources allocated to it, which they can use to perform required CRUD operations on any asset in the ASIK implementation 200. Core ASIK Participants have their own ID, which is used by the ASIK 100 to initiate requests with the ASIK's API layer 140. For example, in an ASIK Track configuration, there may be at least four different participants: Supply Chain Admin, Auditor, Internal Auditor, User/Participant, and the like.

An ASIK Track application 110 takes into consideration the multi-tenancy system with the help of the ASIK Track Tenant Onboarding Service 120 including ASIK Track Tenant Onboarding Service code and data 120′ that is accessed via the ASIK Onboarding Service API Interface 210. The ASIK Track Tenant Onboarding Service 120 lets multiple clients (Tenants) use a single application without the Tenants knowing the service operations. Internally, the ASIK Track Tenant Onboarding Service 120 creates a different database for each Tenant so that their details could be differentiated. Each Tenant performs its own operations in its own database without being aware that it is doing so. By using multi-tenancy, one application may be created and then deployed to as many customers as desired so that a separate solution need not be recreated for each end user. Thus, for a Tenant, the application is a single unit, and all the internal partitions are a black box.

The ASIK Webservice API Layer 130 is an important part of the product as it is the service that the client directly interacts with. With the help of REST APIs, the ASIK Webservice API Layer 130 receives the requests, perform validations/sanitizations on it using node package management (NPM) modules for the JavaScript runtime environment Node.js®, such as express-validator. The NPM modules may be imported by a Node.js® application to establish an interfacing connection with the ASIK Webservice API Layer 130, thereby initiating the rule execution request from the interfaced client application(s) 110.

Once the data is formatted, the data is forwarded to the next layer which is the ASIK Webservice API layer 140. The ASIK Webservice API layer 140 is referred to herein as the service within the ASIK Track's Webservice and the external ASIK Track services as well (services outside of webservice). The job of identifying the type of request and forwarding it to the appropriate service is done by the ASIK Webservice API Layer 140. Some of the requests are handled by ASIK Webservice API Layer 140 entirely, while for other operations, it takes help from the ASIK Track's other services like Batch Composer Service, Aggregation Engine Service, etc. which all fall under the ASIK Track Webservice API Layer 140. Such services are not webservices but are called through webservices depending upon the request.

For example, for creating a workflow (an entity in ASIK Track), only the webservice is required, so the call will be straightforward. However, to perform aggregation (an operation in ASIK Track), the ASIK Track Webservice will perform the required request validations and upon successful validation, will forward the request to Track's Aggregation Engine Service to perform aggregation functions (count, max, min, average, sum). The services in the ASIK Webservice API Layer 130 connect with each other by using either REST APIs or Apache Kafka. Each service is designated with a part of the job, which the service completes and sends the request further to complete the rest of the job.

The ASIK Tenant Onboarding Service 120, ASIK Webservice API Layer 130, ASIK Webservice API Layer 140, Blockchain Platform Specific Service Layer 150, ASIK Chaincode 170, and Blockchain Platform 180, and the interfaces 125, 145, and 165 are common to all implementations, identical to FIG. 1. Below them, the Blockchain Specific Node.js® Fabric Service Layer 150′ realizes the facade for all platform operations. Supporting the Blockchain Specific Node.js® Fabric Service Layer 150′ directly through its dependency on the Blockchain Platform specification 180 is the Fabric CouchDB implementation 220, which is directly accessed for certain indexing capabilities. In a Fabric realization, the schema-index modification and user privileges are partially implemented in the Blockchain Specific Node.js® Fabric Service Layer 150′, which calls the Fabric CouchDB implementation 220 directly.

The Fabric CouchDB® feature 220 supports the Blockchain Platform Specific Service Layer 150 directly, through its dependency on the Blockchain Platform 180. The Fabric CouchDB® feature 220 is utilized to directly access certain indexing capabilities. The Blockchain Platform Specific Service Layer 150′ may make GET calls to CouchDB® 220 (through the internal cache service) but the POST calls or the data operations on the blockchain may be performed only by the ASIK Track Chaincode 170. Different types of users have access to different types of data operations. These users may be registered on the ASIK Track Blockchain Platform 180 using the Hyperledger® Fabric Certificate Authority. Also, the implementation of the ASIK 100 on Hyperledger® Fabric may allow the installation of smart contracts on the Blockchain Platform 180. This way the business logic is split between the Blockchain Specific Node.js® Fabric Service Layer 150′ and the Blockchain Platform 180 itself.

ASIK Track Services invoke the ASIK Track Chaincode 170 through a Fabric Peer connection 230 that hosts ledgers and smart contracts needed for a Chaincode 170 to update the ledger 190. Fabric Peer 230 hosts instances of ledgers and smart contracts for the blockchain network. The ledgers immutably record all transactions generated by smart contracts (which in Hyperledger® Fabric are contained in a Chaincode 170 or smart contract, which is a piece of code that accesses the ledger written in a supported programming language). Smart contracts and ledgers are used to respectively encapsulate the shared processes and shared information in a network. Through Fabric Peer 230, applications can execute chain codes to query or update a ledger.

The actual calls to the Blockchain Platform 180 are made through the ASIK Track Chaincode 170. Once the ASIK Track Chaincode 170 makes a call to update the ledger 190, the response (success/failure) is sent back to the Blockchain Platform Specific Service Layer 150 or the ASIK Webservice API Layer 130. After invoking the ASIK Track Chaincode 170, the Blockchain Platform Specific Service Layer 150 sends the response back to the ASIK Webservice API Layer 130 which, in turn, sends it back to the client application 110. Since the ASIK Track configuration 200 is a multi-tenant system, it incorporates multiple levels of access control. To perform any operation on transactional data (read or write), the caller provides the Tenant's ID as well as the Core ASIK Participant's ID. The hierarchy of bodies in the ASIK 100 may be represented for Platform Admin, Tenant Administrator, and Core ASIK Participants as follows:
Platform Admin>Tenant Administrator>Core ASIK Participants>ASIK Specific data.

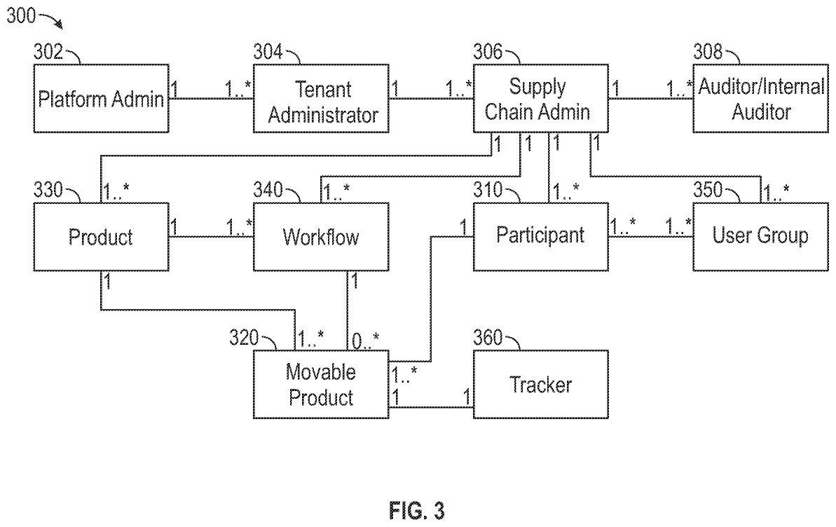

FIG. 3 is a diagrammatical view 300 of ASIK Track system objects for an implementation of an ASIK Track application in a sample configuration. In particular, FIG. 3 explains the relationship between various database entities of the ASIK Track configuration 200. The data realization of ASIK 100 on Fabric involves four roles: Platform Admin 302, Tenant Administrator 304, Supply Chain Admin 306, and Auditor/Internal Auditor 308. Platform Admin 302 is enrolled at the time of product deployment. This role is responsible for enrolling tenants into the system 300. Tenants have an ID and secret, which they can use to Create/Read/Update/Delete rules and functions. Tenants are also responsible for creating applications 110. Applications 110 have their own ID and secret, which is used to initiate rule execution requests with the product's API layer. Multiple rules may be grouped that are intended to be executed together for a transaction.

In FIG. 3, the numbers at either end of the connecting links signify the relationship between the entities in terms of their numbers. For example, in FIG. 3, Participant 310 is marked as “1” and Movable Product 320 as “1*”, which means that one Movable Product 320 can be related to only one Participant 320, but one Participant 310 can be related to any number of Movable Products 320. FIG. 3 shows that, for example, in terms of ASIK Track:
Platform Admin>Tenant Administrator>Supply chain admin>ASIK's Transactional data
Platform Admin>Tenant Administrator>Supply chain admin>Auditor/Internal Auditor>ASIK's Transactional data
Platform Admin>Tenant Administrator>Supply chain admin>User>ASIK's User or user's group related Transactional data

The ASIK's implementation on Hyperledger® Fabric allows the installation of Smart Contracts/Chaincode on the Blockchain platform 180. ASIK Chaincode 170 includes the core functionality of the ASIK. In the ASIK Track configuration, the ASIK Chaincode 170 has the functionality to create all kind of transactional data on Hyperledger® Fabric, including creation of Participant 310, Movable Product 320, Product 330, Workflow 340, User Group 350, Supply Chain Admin 306, Tracker 360, and the like.

The Blockchain Platform Specific Service Layer 150′ accepts inputs from the ASIK Webservice API Layer 130 and translates the inputs to action by invoking the ASIK Chaincode 170 and the Fabric CouchDB® world state database 220. The Blockchain Platform Specific Service Layer 150′ interacts with the Hyperledger® Fabric Certificate Authority to generate the certificates for all the roles involved in the ASIK 100. In case of ASIK Track 200, the Hyperledger® Fabric Certificate Authority will register the User (participant, supply chain admin, auditor, internal auditor) and generate the certificates. These certificates will be used when that user makes any request on the ASIK 100 using the ASIK Webservice API Layer 130 to verify the user on the Hyperledger® Fabric network.

The ASIK Tenant Onboarding Service 120 implements various phases during Tenant creation. For example, a Fabric resources allocation phase may allocate dedicated or shared resources (depending on the client/user request) and may create resources on the fly as per the request the ASIK 100 uses for the BNO service for the Blockchain network. In a channel creation and smart contract deployment phase, a dedicated channel for the Tenant may be created and the Chaincode 170 may be installed and initialized in that channel. In sample configurations, the channel is a communication channel between two or more nodes of the network for use in conducting confidential transactions. In a CouchDB® View creation phase, a dedicated database in a CouchDB® node may be created after deploying the smart contract or Chaincode 170. For a data retrieval process, view documents also may be created in the Tenant specific Couch DB® 220. In a Kafka Topic partition creation phase, a dedicated configurable number of partitions may be added for the Tenant to ensure faster processing. Finally, in an Elasticsearch Indices creation phase, the Blockchain Platform Specific Service Layer 150 may use Elasticsearch to create Tenant specific indices for faster data retrieval.

The ASIK Webservice API Layer 130 has the APIs exposed that the client application 110 will use. In the ASIK Track configuration, there are a set of APIs exposed to the client application 110 that cover the functionality of ASIK Track. Sample APIs for ASIK Track are listed in Table 1 below:

TABLE 1

| Tag | API/Functionality |
|---|---|
| Supply Chain | Create/Get Supply Chain Admin |
| Admin | |
| User | Create/Get User |
| User Group | Create/Get User Group |
| Auditor | Create/Get Auditor |
| Internal Auditor | Create/Get Internal Auditor |
| Context Variables | Get Context Variables |
| Dispute | Create/Get/Resolve Dispute |
| Product | Create/Get Product |
| Workflow | Create/Update/Edit/Get Workflow |
| | Get Movable Product by attribute names and some |
| | other filtration |
| | Get Movable Product count based on visibility |
| | settings |
| Movable Product | Create/Update/Transfer/Receive/Reject Movable |
| | Product |
| | Execute Last Functional Node |
| | Get Node execution log |
| Tracker | Get tracker document by Movable Product ID |
| | Get tracker document by Movable Product ID and |
| | attribute name |

Table 1 demonstrates the different types of tags and the APIs or functionalities related to them. These REST APIs are exposed to the client applications and are responsible to perform unique functionalities to fulfill the requirements of the client application 110. For example, the tag ‘USER’ has a ‘Create User’ API that gives the client applications 110 a way to create users which in turn may create/transfer/receive movable products.

The Blockchain Platform Specific Service Layer 150 may cover the request-response cycle. Table 1 illustrates the ASIK Track functionality in a sample configuration. A separate service may be created for each tag in Table 1. The structure of this layer is shown by way of example in FIG. 4.

FIG. 4 is a flow diagram 400 illustrating the control flow of a sample configuration of ASIK Track. FIG. 4 illustrates the interaction of the different components of ASIK Track to complete the control flow from and back to client application(s) 110. The client application 110 connects with the ASIK Track 200 which in turn connects with external services 410 like Redis, PostgreSQL, Elasticsearch, etc. via client connectors 415 to attain the desired functionality.

The ASIK Track Webservice API Layer 130 receives the commands directly from the client application(s) 110. The ASIK Track Webservice API Layer 130 is also the layer responsible for returning the response (success or failure) back to the client application 110 after processing the request (425). The ASIK Track Webservice API Layer 130 transfers the request to the ASIK Track Middleware 420 for sanitizing the input. The ASIK Track Middleware 420 validates the input from the ASIK Track Webservice API Layer 130 and makes sure that the request adheres to the predefined schema. The ASIK Track Middleware 420 is also responsible for sanitizing the input and converting it to the format that the ASIK Track Service Layer 150 needs for processing the input further (430). At any point, if the request does not match the predefined schema, the request is rejected and moved back to the ASIK Track Webservice API Layer 130 (435). After validation, the request is transferred to the ASIK Track Service Layer 150.

In sample configurations, the ASIK Track Service Layer 150 is a group of one or more ASIK Track services. Each service is responsible for performing the functionality assigned to it and returning the response to the next/previous service. The client connection or connectors 415 to external services 410 like Redis, Kafka, PostgreSQL, Elasticsearch, CouchDB®, etc. are also established in the ASIK Track Service Layer 150. The client connection or connectors 415 provide a layer where the ASIK Track Webservice Layer 150 interacts with the external services 410 (440). ASIK Track Service Layer 150 is responsible for the processing of each functional part of ASIK Track. A separate service file is created to take care of the processing of each functional part of ASIK Track (445). ASIK Track Service Layer 150 decides to call the next service based on the request received. Data received from an external service 440 may be returned back to the respective service (450). In the Blockchain Specific ASIK Track Service Layer 150′, the ASIK Track service may communicate with the Hyperledger® Fabric network (455).

In sample configurations of ASIK Track, pre-configured scenarios and business rules are used to aggregate the transactions for one attribute to provide cumulative results after committing the same over the blockchain to secure the result. In an ASIK Track configuration, a few nodes are added for business features. Each node includes a set of instructions given by client application 110 in the form of a JavaScript function (Script Node, Transition Node, Workflow Trigger Node) or a third party API execution (Service Node) to perform some operations related to ASIK Track. In an example, the nodes may include a script node, a service node, a transition node, and a workflow trigger node.

A script node cannot be the first node in the workflow. An example declaration may be: {{{foo}}={{bar}}+10;}. Two or more script nodes can be consecutive. The script nodes will not belong in the user group node mapping but may belong in a node ID transfer sequence. At the time of instance movement, if the instance follows a path through the script node, then the script mentioned on the script node will get executed. Attribute values set in the script node may be set with an attribute and may be visible on the next group node after the script node. In case of any failure on a script/service node, the instance will remain with the previous group node. For example, for a workflow: User Group Node 1>Script Node 1>User Group Node 2, if in the script node the attribute value for ABC is set as 123, then User Group Node 2 will see the attribute value for ABC as 123.

A service node also cannot be the first node in the workflow. Two or more service nodes can be consecutive. The service nodes may not belong to the user group node mapping but may belong to the node ID transfer sequence. At the time of instance movement, if the instance follows a path through the service node, then the service node may be executed by calling a third party API. The service node waits for the response from the third party API until a configured timeout. The service node can do retry attempts in accordance with configured retry value times.

A transition node also cannot be the first node. The transition nodes may not belong to the user group node mapping but may belong to the node ID transfer sequence. At the time of instance movement, if the instance follows a path through the script node, then the script mentioned on the transition node will get executed and the transition node will return ‘to node id’.

The workflow trigger node also cannot be the first node in the workflow. The workflow trigger nodes also may not belong to the user group node mapping but may belong to the node ID transfer sequence. At the time of instance movement, if the instance follows a path through a workflow trigger node, then a Batch Composer Service (BCS) may be called to generate a batch and the generated batch ID will be returned to the client application 110. For example, the following is an example declaration of a workflow trigger node:

```
“aggregation_settings”: {
  “aggregation”: {
    “script”: “{ {DL.AGG.var1} } = AGGR(\“SUM\”, \“{foo}\”);”
  },
  “post_aggregation”: {
    “script”: “{ \n { {DL.WFINSTANCE.wf1} } = { {DL.AGG.var1} } +150;\n { {foo} } =
{ {DL.AGG.a1} } + 500;\n}”
  },
  “condition”: {
    “script”: “function( ){ \n if ( { {bar} } = = 1001 && { {foo} } > 10 ) { \n return true; \n } e
lse { \n return false; \n } \n}”
  },
  “scheduler”: {
    “scheduler_type”: “DAILY”,
    “scheduler_execution_time”: {
      “execution_time”: “18:13:00”,
      “time_zone”: “UTC+05:30”
    }
  }
}
```

In sample configurations, the following services may be included in an ASIK Track application.

A Batch Composer Service (BCS) may be provided that is responsible for generating a batch of the movable product related transactions like transfer, receive, update, last node execution, etc. The BCS returns a generated batch ID to the ASIK Track Service and sends the generated batch ID in a Kafka queue for performing aggregation. Until the condition in aggregation settings given by client application 110 is false, the transactions may be part of the same batch. Once the condition is true, the batch may be completed.

An Aggregation Engine Service may be provided that is responsible for performing the aggregation and post aggregation processes. The aggregation may be performed on movable product attribute values. For example, SUM, MIN, MAX, COUNT, and AVG aggregation functions may be supported. Two kinds of aggregations may be implemented including and Eager Aggregation, which is a runtime aggregation that is performed as the transactions/requests are received, and a Lazy Aggregation, which performs the aggregation once the batch completes. A post aggregation may be performed after the aggregation is completed. A post aggregation is usually used to modify a value of an attribute as per the defined script in the workflow trigger node.

A Movable Product Worker Service may be provided that is responsible for completing the next flow of the defined workflow after the workflow trigger node. For example, in the case of the example Workflow 1: User Group Node 1>Workflow Trigger Node 1>User Group Node 2, once aggregation and post aggregation are completed, the request will come to the Movable Product Worker Service via a Kafka queue. The Movable Product Worker Service will check that the next node is a group node so it will perform the transfer functionality on User Group Node 2. On the other hand, in the case of example Worflow2: User Group Node 1>Workflow Trigger Node 1>Workflow Trigger Node 2>User Group Node 2 group1>wtn1>wtn2>group2, once aggregation and post aggregation are completed for the Workflow Trigger Node 1, the request will come to the Movable Product Worker Service via a Kafka queue. The Movable Product Worker Service will check that the next node is a workflow trigger node. If so, the Movable Product Worker Service calls the Batch Composer Service for the processing of Workflow Trigger Node 2. On completion of the Workflow Trigger Node 2's processing, the Movable Product Worker Service may perform the transfer functionality on User Group Node 2.

A Movable Product Tracing Data Handler Service may be provided that is used to manage the tracing details of the movable products. The Movable Product Tracing Data Handler Service has a background job of loading the tracing information on persistence environment (Postgres) based on defined business rules. The Movable Product Tracing Data Handler Service also has the API to view the tracing details for the provided movable product. By using the Movable Product Tracing Data Handler Service, the user/client can trace the list of aggregated instances with all key attributes (or) with Movable Product ID.

A Scheduling Composer Service may be provided that is responsible for creating a scheduling job for the workflow trigger node. The scheduling job configurations may be entered by the client application 110 while creating a workflow as below:

```
“scheduler”: {
  “scheduler_type”: “DAILY”,
  “scheduler_execution_time”: {
    “execution_time”: “18:13:00”,
    “time_zone”: “UTC+05:30”
  }
}
```

This scheduling job may trigger a request to perform an aggregation for saved workflow details and the batch ID. The Scheduling Composer Service may receive a request when the client application 110 creates a workflow with scheduler configurations.

As noted above, the ASIK Track Blockchain Specific Service Layer 150′ does the job of communicating with the Hyperledger® Fabric (blockchain) Network. The ASIK Track Blockchain Specific Service Layer 150′ holds the major business logic, manages the data operations, and invokes the Blockchain Platform 180. The ASIK Track Blockchain Specific Service Layer 150′ accepts inputs from the ASIK Track Service Layer 150 and creates the request in a format to invoke the ASIK Chaincode 170. The ASIK Chaincode 170 is the layer in which the ASIK 100 submits the request on the Blockchain Platform 180 and puts data in the ledger and state database (e.g., CouchDB®). The ASIK Track Blockchain Specific Service Layer 150′ also interacts with the Hyperledger® Fabric Certificate Authority to generate the certificates for all the roles involved in ASIK 100. In the case of an ASIK Track configuration, the Hyperledger® Fabric Certificate Authority may register the User (participant, supply chain admin, auditor, internal auditor) and generate the certificates. These certificates may be used when that user makes any request on the ASIK 100 using the ASIK Track Webservice API Layer 130 to verify the user on the Blockchain Platform 180.

Table 2 below describes a sample list of the different microservices that are created in ASIK Track for catering to various functionalities and business requirements.

TABLE 2

| Service | Purpose |
|---|---|
| Workflow and User | This service is responsible for all the transactions related to |
| Management Service | workflow and user. |
| Movable Product Service | This service is responsible for all the transactions related to |
| | Movable Product. |
| Batch Composer Service | This service is responsible for generating a batch of the |
| | movable product transactions and sending it ahead for the |
| | aggregation to be performed. |
| Movable Product Worker | This service is responsible for all the aggregated |
| Service | transactions to complete the next flow of the defined |
| | workflow. |
| Movable Product Data Handler | This service is responsible for saving a snapshot of |
| and Tracing Service | Movable Product and a trace of its attributes. |
| Scheduling Composer service | This service is responsible for scheduling a cron job which |
| | will trigger on defined time interval. That job will be |
| | triggering a request to perform an aggregation for saved |
| | workflow details. |
| Discovery and Listener | This service is responsible for allocating the Source |
| Management Service | extractor service's instance so that data will be |
| | synchronized to Elasticsearch. |
| Resource Management Service | This service is responsible for all allocating the Fabric |
| | resources for the tenant. |
| Tenant Management service | This service is responsible for creating the tenant in a |
| | system and allocating the resources for the same. |
| Aggregation Engine Service | This service is responsible for aggregating the movable |
| | product attribute values or assigning a value to an attribute |
| | as per the defined script in the workflow trigger node. |
| Source Extractor Service | This service is responsible for extracting the document |
| | from Hyperledger ® Fabric Peer as an event on successful |
| | block mining and sending it to the Transformer and Loader |
| | service. |
| Transformer and Loader service | This service is responsible for saving the extracted |
| | document from Hyperledger ® Fabric peer to Elasticsearch |
| | for the faster retrieval of the data. |

Each service listed in Table 2 may contain multiple APIs that are exposed to the client applications 110 with which the ASIK platform is/are interfaced. For example, the service ‘Movable Product Data Handler and Tracing Service’ is responsible for saving a snapshot of the Movable Product and a trace of its attributes.

FIG. 5 is a flow diagram 500 illustrating the operation of an ASIK 100 in a general configuration.

As illustrated in FIG. 5, the initiation point of the ASIK 100 is the enterprise level user who deals with the front end of a distributed ledger product. The process originates from a user request or input at 510. The data provided by the user is a request to perform some sort of transaction 185 on the Blockchain network. The request can be made by the user from a user interface 520, by an HTTPS request, or by a request made from RESTful APIs 140.

Usually the request is transferred via a responsive user interface 520 of the distributed ledger product's front-end, HTTPS requests, or from the RESTful APIs 140. These requests get routed from end points (APIs) to the ASIK Webservice Layer 150 in the form of functions [f(x)Webservice]. The nature of the request determines the necessary function to be called on the ASIK Webservice layer 150, which leads the business logic to be identified in this step.

The request may be validated by the middleware 420 before the package is routed to the ASIK Webservices Layer 150. The middleware 420 checks if the provided request has all parameters in accordance with business requirements. The middleware 420 also handles certain special functions, for example, the case sensitivity of parameter or input variable names and such similar features.

Depending upon the business requirement, the appropriate function to cater those requirements is selected by the Webservice functions [f(x)Webservice] of the ASIK 100. The request function then triggers a similar function on the Chaincode 170 [f(x)Chaincode]. The functions act as a modulator that translates input requests into transactions that can be executed on the Blockchain platform 180 via the Chaincode 170. Thus, for every request function, there exists a similar response function which translates information in a format that is interpreted by the Blockchain platform 180. The business problem is solved in the Chaincode layer 170, which is responsible for all interactions with the Blockchain platform 180.

Once the transactions 185 are executed on the Blockchain platform 180, business operations are complete. The state of transactions 185 is then updated onto a preconfigured state database (e.g., CouchDB®) 220 that keeps track of every transaction 185 made by the enterprise. All transactions within the ASIK 100 may be performed in accordance with a security protocol (e.g., Transport Layer Security (TLS) 1.0) so that internal and external transactions 185 are transmitted over a secure channel.

Whenever transactions 185 are executed on the Blockchain platform 180, the process of updating the ledger 190 happens sequentially. Irrespective of the status of the transaction, i.e. success (530) or failure (540), a transaction 185 with a unique ID is updated on the ledger 190. The smart contracts/Chaincode 170 may be customized by the ASIK 100 to further enhance the transaction reports.

Whenever a transaction 185 fails (540), an error handling system such as Technical Error Reprocessing 550 assigns the transaction 185 to the ASIK 100. ASIK 100 identifies the nature of the error and reruns the transaction 185 from the appropriate start point.

After business operations, the request is complete, and the response propagates to the ASIK Webservices Layer 150 through the Chaincode 170. The response can then be displayed as desirable output via a user interface dashboard on the user interface 520. Thus, the lifecycle of a request function originating at the ASIK Webservices Layer 150 ends in the same position in the form of a response.

Those skilled in the art will appreciate that the ASIK 100 as implemented in Fabric/Node.js® has the advantages of decentralization, secure data encryption, ease of implementation and high fraud protection. The ASIK 100 preserves and communicates the core functionality of the blockchain to the user without disrupting the blockchain capabilities and contents. The ASIK 100 also provides a ‘Plug and Play’ solution equipped with preconfigured scenarios. The user feeds a request to the ASIK Webservices Layer 150 using conventional user interface methods or HTTPS requests and the ASIK 100 handles the rest. Users have minimal factors to configure to use the ASIK 100. The business logic is precisely constructed and then deployed onto peers within a channel, and the business logic is enforced on the blockchain. The modular nature simplifies the operation of performing transactions on the blockchain that are adapted to specific use cases that abstract away any need for a technical understanding of the blockchain, thereby making the blockchain applications rather simple to use. Also, the most sought-after business utilities and functionalities are preconfigured as reusable with rules via a programming interface, which ensures enterprises can use the same solution for a variety of complexities. It will be further appreciated that the blockchain rules engine described in U.S. patent application Ser. No. 17/653,085 may also be used by the ASIK 100 to enforce business rules as well as to enable the creation of new rules without going into the user application to do so. The content of U.S. patent application Ser. No. 17/653,085 is hereby incorporated by reference in its entirety.

The ASIK 100 also provides a reliable backwards compatible interface between users and the blockchain. The users do not need to understand the blockchain to reap the benefits of the ASIK 100 as the ASIK 100 manages all operations on the blockchain. Also, since the ASIK 100 provides a collection of APIs that are exposed to meet a certain business requirement, the ASIK 100 can be used in collaboration with any technology stack very similar to compatibility of an API. The ASIK 100 is also blockchain agnostic as it works with both chaincodes and smart contracts and works with several blockchain networks such as Ethereum, Hyperledger® Fabric, and others. The ASIK 100 also works across all major technology stacks and programming languages and interacts with a variety of compatible blockchain and cloud networks via load balanced REST APIs.

Since the ASIK 100 outlines the semantics, syntax, interfaces, and requirements that enable the ASIK 100 to work across all major technology stacks and programming languages, business service layers can be developed in different technologies, and new developments can be done in the latest technology frameworks to leverage the technological benefits. The ASIK 100 provides the semantics and syntax already familiar to non-blockchain programmers and is identical across all blockchain platforms to enable rapid application development. ASIK 100 further provides a pluggable platform that can be interfaced with multiple client applications with only configuration changes. Powerful load balanced REST APIs may be used to interact with a variety of blockchain frameworks with relative ease. The resulting framework facilitates upgrades and releases of the blockchain. Also, by implementing multi-tenancy on the blockchain, multiple tenants are enabled to create and manage data on the blockchain and to physically separate the data of respective tenants. All the operations with respect to tenants and core ASIK participants are logged securely on the blockchain within a multi-tenant framework. Finally, the modular framework of preconfigured features and functionalities enables the ASIK 100 to provide a platform to deliver multiple business use cases with ease.

These and other advantages will become apparent to those skilled in the art from the above description.

### Computer Embodiment

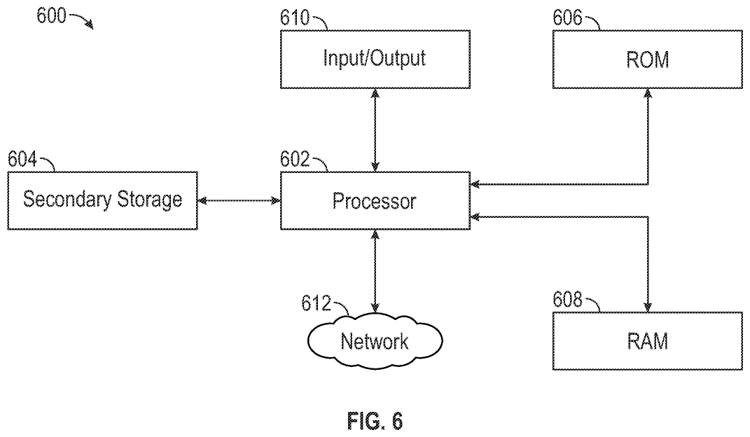

FIG. 6 is a block diagram of a typical, general-purpose computer 600 that may be programmed into a special purpose computer suitable for implementing one or more embodiments of the ASIK 100 disclosed herein. The ASIK 100 described above may be implemented on any general-purpose processing component, such as a computer with sufficient processing power, memory resources, and communications throughput capability to handle the necessary workload placed upon it. The computer 600 includes a processor 602 (which may be referred to as a central processor unit or CPU) that is in communication with memory devices including secondary storage 604, read only memory (ROM) 606, random access memory (RAM) 608, input/output (I/O) devices 610, and network connectivity devices 612. The processor 602 may be implemented as one or more CPU chips or may be part of one or more application specific integrated circuits (ASICs).

The secondary storage 604 is typically comprised of one or more disk drives or tape drives and is used for non-volatile storage of data and as an over-flow data storage device if RAM 608 is not large enough to hold all working data. Secondary storage 604 may be used to store programs that are loaded into RAM 608 when such programs are selected for execution. The ROM 606 is used to store instructions and perhaps data that are read during program execution. ROM 606 is a non-volatile memory device that typically has a small memory capacity relative to the larger memory capacity of secondary storage 604. The RAM 608 is used to store volatile data and perhaps to store instructions. Access to both ROM 606 and RAM 608 is typically faster than to secondary storage 604.

The devices described herein may be configured to include computer-readable non-transitory media storing computer readable instructions and one or more processors coupled to the memory, and when executing the computer readable instructions configure the computer 600 to perform method steps and operations described above with reference to FIG. 1 to FIG. 5. The computer-readable non-transitory media includes all types of computer readable media, including magnetic storage media, optical storage media, flash media and solid-state storage media.

It should be further understood that software including one or more computer-executable instructions that facilitate processing and operations as described above with reference to any one or all of steps of the disclosure may be installed in and sold with one or more servers and/or one or more routers and/or one or more devices within consumer and/or producer domains consistent with the disclosure. Alternatively, the software may be obtained and loaded into one or more servers and/or one or more routers and/or one or more devices within consumer and/or producer domains consistent with the disclosure, including obtaining the software through physical medium or distribution system, including, for example, from a server owned by the software creator or from a server not owned but used by the software creator. The software may be stored on a server for distribution over the Internet, for example.

Also, it will be understood by one skilled in the art that this disclosure is not limited in its application to the details of construction and the arrangement of components set forth in the description or illustrated in the drawings. The embodiments herein are capable of other embodiments, and capable of being practiced or carried out in various ways. Also, it will be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Further, terms such as up, down, bottom, and top are relative, and are employed to aid illustration, but are not limiting.

The components of the illustrative devices, systems and methods employed in accordance with the illustrated embodiments may be implemented, at least in part, in digital electronic circuitry, analog electronic circuitry, or in computer hardware, firmware, software, or in combinations of them. These components may be implemented, for example, as a computer program product such as a computer program, program code or computer instructions tangibly embodied in an information carrier, or in a machine-readable storage device, for execution by, or to control the operation of, data processing apparatus such as a programmable processor, a computer, or multiple computers.

A computer program may be written in any form of programming language, including compiled or interpreted languages, and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. Also, functional programs, codes, and code segments for accomplishing the techniques described herein may be easily construed as within the scope of the present disclosure by programmers skilled in the art. Method steps associated with the illustrative embodiments may be performed by one or more programmable processors executing a computer program, code or instructions to perform functions (e.g., by operating on input data and/or generating an output). Method steps may also be performed by, and apparatus may be implemented as, special purpose logic circuitry, e.g., an FPGA (field programmable gate array) or an ASIC (application-specific integrated circuit), for example.

The various illustrative logical blocks, modules, and circuits described in connection with the embodiments disclosed herein may be implemented or performed with a general-purpose processor, a digital signal processor (DSP), an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory may be supplemented by or incorporated in special purpose logic circuitry.

Those of skill in the art understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such the processor may read information from, and write information to, the storage medium. In the alternative, the storage medium may be integral to the processor. In other words, the processor and the storage medium may reside in an integrated circuit or be implemented as discrete components.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store processor instructions. The term “machine-readable medium” shall also be taken to include any medium, or combination of multiple media, which is capable of storing instructions for execution by one or more processors, such that the instructions, when executed by one or more processors cause the one or more processors to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” as used herein excludes signals per se.

The above-presented description and figures are intended by way of example only and are not intended to limit the illustrative embodiments in any way except as set forth in the appended claims. It is noted that various technical aspects of the various elements of the various exemplary embodiments that have been described above may be combined in numerous other ways, all of which are considered to be within the scope of the disclosure.

Accordingly, although exemplary embodiments have been disclosed for illustrative purposes, those skilled in the art will appreciate that various modifications, additions, and substitutions are possible. Therefore, the disclosure is not limited to the above-described embodiments but may be modified within the scope of appended claims, along with their full scope of equivalents.

1.-12. (canceled)

13. A method for interfacing a client application to a blockchain platform that manages a blockchain, comprising:
receiving, by an application programming interface (API) layer, a request from the client application to perform a transaction on the blockchain;
formatting, by the API layer, data associated with the request;
receiving, by a service layer, at least one command and formatted data associated with the request;
identifying, by the service layer, a type of the request;
describing, by the service layer, preconfigured features and functionalities that interact with the blockchain platform in accordance with a predetermined use case of the method for interfacing the client application to the blockchain platform;
based on the type of the request, forwarding, by the service layer, the at least one command and formatted data for execution on the blockchain;
managing, by a chaincode, data operations for the preconfigured features and functionalities that interact with the blockchain platform for the predetermined use case by translating the at least one command into at least one transaction for execution on the blockchain platform in accordance with the preconfigured features and functionalities that interact with the blockchain platform in accordance with the predetermined use case;
returning results of execution of the at least one transaction and formatted data on the blockchain platform to the service layer; and
returning, by the service layer, the results of execution of the at least one transaction and formatted data on the blockchain platform to the client application.

14. The method of claim 13, further comprising exposing APIs to the client application that the client application may use to access the preconfigured features and functionalities that are to interact with the blockchain platform in accordance with the predetermined use case.

15. The method of claim 13, further comprising providing load balanced representational state transfer (REST) APIs to the client application, where the REST APIs are adapted to interact with the blockchain platform.

16. The method of claim 13, further comprising enabling multiple client applications to create and manage data on the blockchain platform using the API layer, service layer, and chaincode.

17. The method of claim 13, wherein the formatting of data associated with the request comprises the API layer validating the request from the client application, validating user details received in the request from the client application, checking permission for the user to perform the request from the client application, and preparing the request for submission to the blockchain platform.

18. The method of claim 13, wherein the API layer, service layer, and chaincode are adapted to support three roles comprising a Platform Admin, a Tenant, and Core ASIK Participants, further comprising the Platform Admin enrolling client applications, the Tenant performing create, read, update, and delete operations on the formatted data using an ID and resources allocated to the Tenant, and the Core ASIK Participants initiating requests with the API layer using their own IDs.

19. The method of claim 18, each Tenant has a database, further comprising each Tenant performing operations in its own database.

20. The method of claim 13, further comprising describing, by the service layer, the preconfigured features and functionalities by outlining a semantics and syntax and at least one interface through which the at least one command and formatted data interact with the blockchain platform for the predetermined use case.

21. The method of claim 13, wherein the predetermined use case corresponds to a business service to be performed on the blockchain.

22. The method of claim 13, further comprising accessing, by the chaincode, a blockchain ledger and smart contracts of the blockchain platform to query or update the blockchain ledger.

23. The method of claim 22, further comprising securely logging all operations of the client applications to the blockchain ledger.

24. The method of claim 13, further comprising the service layer accepting inputs from the API layer and translating the inputs to action by invoking the chaincode and a state database.

25. A non-transitory computer-readable medium having instructions stored thereon that when executed by one or more processors cause the one or more processors to implement a method for interfacing a client application to a blockchain platform that manages a blockchain, the instructions comprising:
first instructions for generating an application programming interface (API) layer that receives a request from the client application to perform a transaction on the blockchain and formats data associated with the request;
second instructions for generating a service layer that receives at least one command and formatted data associated with the request, identifies a type of the request, and based on the type of the request, forwards the at least one command and formatted data for execution on the blockchain, and returns results of execution of the at least one command and formatted data on the blockchain platform to the client application, the service layer further describing preconfigured features and functionalities that interact with the blockchain platform in accordance with a predetermined use case of the method for interfacing the client application to the blockchain platform; and
third instructions for generating a chaincode that manages data operations for the preconfigured features and functionalities that interact with the blockchain platform for the predetermined use case by translating the at least one command into at least one transaction for execution on the blockchain platform in accordance with the preconfigured features and functionalities for the predetermined use case and by returning results of execution of the at least one transaction and formatted data on the blockchain platform to the service layer.

26. The non-transitory computer-readable medium of claim 25, wherein the API layer exposes APIs that the client application uses to access the preconfigured features and functionalities that interact with the blockchain platform in accordance with the predetermined use case.

27. The non-transitory computer-readable medium of claim 25, wherein the API layer provides load balanced representational state transfer (REST) APIs to the client application, where the REST APIs are adapted to interact with the blockchain platform.

28. The non-transitory computer-readable medium of claim 25, wherein the API layer, service layer, and chaincode are adapted to support a multi-tenant framework whereby multiple client applications may create and manage data on the blockchain platform.

29. The non-transitory computer-readable medium of claim 25, wherein the API layer validates the request from the client application, validates user details received in the request from the client application, checks permission for the user to perform the request from the client application, prepares the request for submission to the blockchain platform, and returns a response from the blockchain platform to the client application.

30. The non-transitory computer-readable medium of claim 25, wherein the API layer, service layer, and chaincode are adapted to support three roles comprising a Platform Admin, a Tenant, and Core ASIK Participants, where the Platform Admin is responsible for enrolling client applications, a Tenant has an ID and resources allocated to it to perform create, read, update, and delete operations on the formatted data, and the Core ASIK Participants have their own ID which is used to initiate requests with the API layer.

31. The non-transitory computer-readable medium of claim 30, wherein each Tenant performs operations in its own database.

32. The non-transitory computer-readable medium of claim 25, wherein the service layer describes the preconfigured features and functionalities by outlining a semantics and syntax and at least one interface through which the at least one command and formatted data interact with the blockchain platform for the predetermined use case.

33. The non-transitory computer-readable medium of claim 25, wherein the predetermined use case corresponds to a business service to be performed on the blockchain.

34. The non-transitory computer-readable medium of claim 25, wherein the chaincode accesses a blockchain ledger and smart contracts of the blockchain platform to query or update the blockchain ledger.

35. The non-transitory computer-readable medium of claim 34, wherein all operations of the client applications are logged securely to the blockchain ledger.

36. The non-transitory computer-readable medium of claim 25, wherein the service layer accepts inputs from the API layer and translates the inputs to action by invoking the chaincode and a state database.
